(19) United States
(12) Patent Application Publication
(10) Pub. No.: US 2015/0234650 A1
(43) Pub. Date: Aug. 20, 2015

(54) METHOD OF MANAGING FIRMWARE AND ELECTRONIC DEVICE THEREOF

(71) Applicant: Samsung Electronics Co., Ltd., Suwon-si (KR)

(72) Inventors: Jong-Tae KIM, Yongin-si (KR); Sang-Eun HA, Suwon-si (KR); Chenchun-Yen IAN, Suwon-si (KR)

(73) Assignee: Samsung Electronics Co., Ltd., Suwon-si (KR)

(21) Appl. No.: 14/186,747

(22) Filed: Feb. 21, 2014

(30) Foreign Application Priority Data
Feb. 19, 2014 (KR) 10-2014-0018955

(51) Int. Cl. G06F 9/445; G06F 9/44

(52) U.S. Cl. CPC G06F 8/665; G06F 9/4401

(57) ABSTRACT

A method for managing firmware and an electronic device are provided. The method includes updating the firmware of the internal device using firmware update information of the internal device, which is logically or physically separated from a kernel (OS) image.

### PRIORITY

This application claims the benefit under 35 U.S.C. § 119(a) of a Korean patent application filed in the Korean Intellectual Property Office on Feb. 19, 2014 and assigned Serial No. 10-2014-0018955, the entire disclosure of which is hereby incorporated by reference.

### BACKGROUND OF THE INVENTION

1. Field of the Invention

The present invention relates to a method for managing firmware and an electronic device thereof.

2. Description of the Related Art

As information and communication technologies and semiconductor technologies have been developed, various electronic devices have been developed into multimedia devices, each of them for providing various multimedia services. For example, each of the electronic devices may provide various multimedia services such as a broadcasting service, a wireless Internet service, a camera service, and a music play service.

The electronic device may include firmware which is a program for controlling hardware. The electronic device may correct its error or add its new function by updating firmware.

The electronic device may include at least one internal device (e.g., a memory, an input/out device, a display, etc.) which performs various functions. Herein, at least the one internal device may embed its own firmware.

The firmware of at least the one internal device may be updated together with firmware (e.g., an Operating System (OS)) of the electronic device which is a host. Accordingly, the firmware of at least the one internal device included in the electronic device is dependent on a version of host firmware. There may be an unnecessary load for newly generating the host firmware to update the firmware of the internal device.

### SUMMARY OF THE INVENTION

When there is input and output of signals which are not related to update of the firmware of the electronic device in the update of the firmware of the electronic device, they may be a problem in that the electronic device fails in updating the firmware or a device which updates the firmware is out of order. For example, updating firmware of a storage device included in the electronic device, there may be a problem in that the electronic device fails in updating the firmware of the storage device or the storage device is out of order because input and output of the storage device, which is not related to the update of the firmware of the storage device, is generated.

An aspect of the present invention is to solve at least the above-mentioned problems and/or disadvantages and to provide at least the advantages described below.

Accordingly, an aspect of the present invention is to provide an apparatus and method for updating firmware of an internal device in an electronic device.

Another aspect of the present invention is to provide an apparatus and method for updating firmware of a corresponding internal device in a state where input and output for the internal device is limited in an electronic device.

Another aspect of the present invention is to provide an apparatus and method for delaying the mounting of system information and updating firmware of a storage device in a state where input and output for the storage device is limited in an electronic device.

Another aspect of the present invention is to provide an apparatus and method for unmounting system information and updating firmware of a storage device in a state where input and output for the storage device is limited in an electronic device.

In accordance with an aspect of the present invention, a method of updating firmware of an internal device in an electronic device is provided. The method includes updating the firmware of the internal device using firmware update information of the internal device, which is logically or physically separated from a kernel (OS) image.

In accordance with another aspect of the present invention, a method of updating firmware of an internal device in an electronic device is provided. The method includes verifying firmware update information for updating the firmware of the internal device while the electronic device is driven, unmounting system information of the electronic device, and updating the firmware of the internal device using the firmware update information.

In accordance with another aspect of the present invention, a method of updating firmware of an internal device in an electronic device is provided. The method includes loading firmware update information of the internal device, which is logically or physically from a kernel (OS) image, into a RAM disc region, updating the firmware of the internal device using the firmware update information loaded into the RAM disc region, and rebooting the electronic device.

In accordance with another aspect of the present invention, an electronic device is provided. The electronic device includes at least one internal device and at least one processor, wherein at least the one processor updates firmware of at least the one internal device using firmware update information of at least the one internal device, which is logically or physically separated from a kernel (OS) image.

In accordance with another aspect of the present invention, an electronic device is provided. The electronic device includes at least one internal device and at least one processor, wherein at least the one processor verifies firmware update information of at least the one internal device for updating firmware among at least the one internal device while the electronic device is driven, unmounts system information of the electronic device, and updates the firmware of at least the one internal device for updating the firmware using the firmware update information.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating configuration of an electronic device according to one embodiment of the present invention;

FIG. 2 is a block diagram illustrating detailed configuration of a processor and a memory of an electronic device according to one embodiment of the present invention;

FIG. 3 is a block diagram illustrating detailed configuration of a processor and a memory of an electronic device according to another embodiment of the present invention;

FIG. 4 is a flowchart illustrating a process of updating firmware of an internal device in an electronic device according to one embodiment of the present invention;

FIG. 5 is a flowchart illustrating a process of updating firmware of an internal device when an electronic device is booted according to one embodiment of the present invention;

FIG. 6 is a flowchart illustrating a process of updating firmware of an internal device based on firmware version in an electronic device according to one embodiment of the present invention;

FIG. 7 is a flowchart illustrating a process of updating firmware of an internal device while an electronic device is driven according to one embodiment of the present invention;

FIG. 8 is a flowchart illustrating a process of updating firmware of an internal device based on firmware version in an electronic device according to another embodiment of the present invention; and

FIG. 9 illustrates configuration of firmware update information according to one embodiment of the present invention.

### DETAILED DESCRIPTION OF EXEMPLARY EMBODIMENTS

Exemplary embodiments of the present invention will be described herein below with reference to the accompanying drawings. In the following description, well-known functions or constructions are not described in detail since they would obscure the invention in unnecessary detail.

Expressions such as “include” or “may include”, etc. which may be used in various embodiments of the present invention indicate that there are invented corresponding function, operation, or element, etc. The expressions do not limit one or more additional functions, operations, or elements, etc. Also, in various embodiments of the present invention, terms such as “include” or “have”, etc. designate that there are characteristics, numbers, steps, operations, elements, components, or combination of them which are described in the present specification. Accordingly, it must be understood that existence or additional possibility of one or more other characteristics, numbers, steps, operations, elements, components, or combination of them is not previously excluded.

In various embodiments of the present invention, expressions “or”, etc. include any of words enumerated together and all combination of the words. For example, “A or B” may include A, include B, or include all of A and B.

In various embodiments of the present invention, expressions such as “the first” or “the second”, etc. may modify various elements of the present invention. However, the elements are not limited by the terms. For example, the expressions do not limit an order and/or importance, etc. of the corresponding elements. The expressions may be used to distinguish one element from other elements. For example, all of a first user device and a second user device are user devices and means different user devices. For example, a first element may be also referred to as a second element without getting out of the scope of right of the present invention. Similarly, the second component may be referred to as the first component without getting out of the scope of right of the present invention.

When it must be described that any component is “connected” or “accessed” to another component, it will be understood that the any component may be directly connected or accessed to the another component, but there may be another component between the any component and the another component. On the other hand, when it may be described that any component is “directly connected” or “directly accessed” to another component, it will be understood that there is no another component between the any component and the another component.

Terms used in the present invention are used to describe a specific embodiment of the present invention merely. The terms are not intended to limit the present invention. A singular expression includes a plural expression unless it has a contextual, clear, and different meaning.

Unless terms are differently defined, all the terms, used in the specification of the present invention, including technical or scientific terms have the same meaning as terms which are commonly understood by a person of ordinary skill in the pertinent art, to which an inventor belongs. Terms such as terms defined in a generally used dictionary must be interpreted as terms having the same meaning which is identical to a contextual meaning of related technology. Unless the terms are clearly defined, they are not interpreted as an ideal or excessively formal meaning

An electronic device according to various embodiments of the present invention may be a device including a storage device. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Moving Picture Experts Group (MPEG) layer 3 (MP3) player, a mobile medical device, a camera, and a wearable device (e.g., a Head Mounted Display (HMD) such as electronic glasses, electronic clothes, an electronic bracelet, an electronic necklace, electronic accessories, an electronic tattoo, or a smart watch).

In accordance with another embodiment of the present invention, the electronic device may be a smart home appliance having a storage device. For example, the smart home appliance may include at least one of a television, a Digital Versatile Disc (DVD) player, an audio, a refrigerator, an air conditioner, a vacuum cleaner, an oven, a microwave oven, a washing machine, an air cleaner, a set-top box, a TV box (e.g., a Samsung HomeSync™, an Apple TV™, or a Google TV™), a game console, an electronic dictionary, an electronic key, a camcorder, and an electronic frame.

In accordance with another embodiment of the present invention, the electronic device may include at least one of various medical devices (e.g., a Magnetic Resonance Angiography (MRA), a Magnetic Resonance Imaging (MRI), a Computed Tomography (CT), an imaging apparatus, an ultrasonic machinery, etc.), a navigation device, a Global Positioning System (GPS) receiver, an Event Data Recorder (EDR), a Flight Data Recorder (FDR), a car infotainment device, electronic equipment for ship (e.g., a navigation device for ship, a gyrocompass, etc.) an avionics device, a security device, and an industrial or home service robot.

In accordance with another embodiment of the present invention, the electronic device may include at least one of a part of furniture or building/structure, an electronic board, an electronic signature input device, a projector, various measuring devices (e.g., a water, electricity, gas, or radio measuring device, etc.), each of them having a storage device. The electronic device according to embodiments of the present invention may be one or combination of one or more of the above-described various devices. Also, it is obvious to a person of ordinary skill in the art that the electronic device according to embodiments of the present invention is not limited to the above-described devices.

Hereinafter, a description will be given for an electronic device according to various embodiments of the present invention with reference to attached drawings. A term “user” used in various embodiments of the present invention may be referred to as a person who uses an electronic device or a device (e.g., an artificial intelligence electronic device) using an electronic device.

Hereinafter, a description will be given for an apparatus for updating firmware of an internal device in an electronic device according to one embodiment of the present invention.

Hereinafter, the internal device according to one embodiment of the present invention may indicate a device which is electrically or mechanically connected to an electronic device. For example, the internal device may be configured as a shape which is connected to the inside of the electronic device through a data bus. For example, the internal device is connected to the electronic device through an external interface such as a Universal Serial Bus (USB) or a serial interface. The internal device may be configured as s shape which may be removable from the electronic device. For example, the internal device may include a memory, a storage device, a keypad, a touch panel, a display device, etc.

Hereinafter, to update firmware of the internal device may indicate a series of operations for updating firmware of a device interface between a storage region for storing data included in the storage device and the device interface for controlling input and output of data for the storage region.

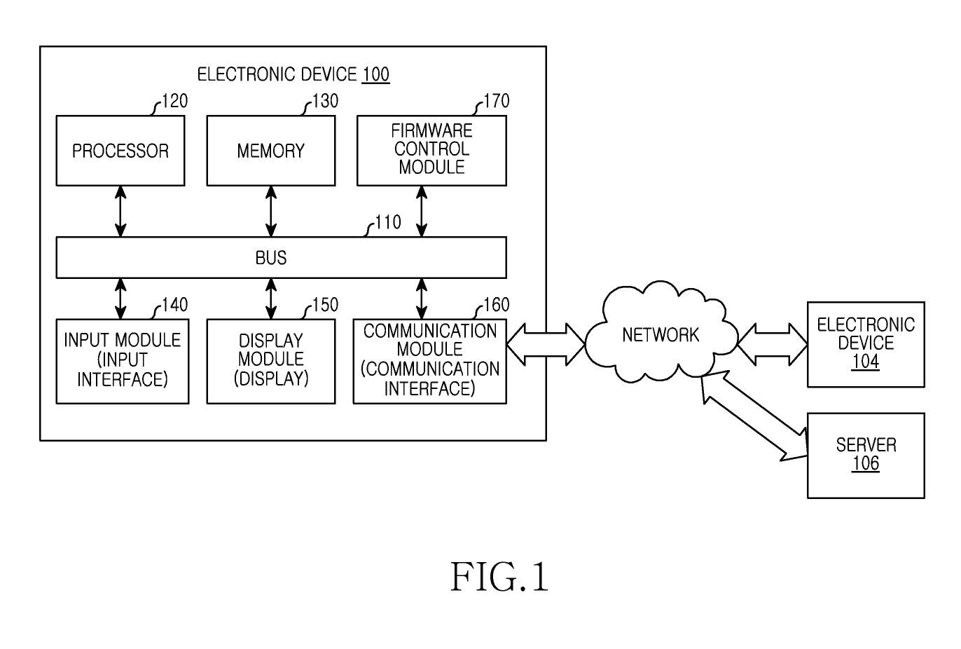

FIG. 1 is a block diagram illustrating configuration of an electronic device according to one embodiment of the present invention.

Referring to FIG. 1, the electronic device denoted by 100 includes a bus 110, a processor 120, a memory 130, an input module (input interface) 140, a display module (display) 150, a communication module (communication interface) 160, and a firmware control module 170. Herein, the processor 120 and the memory 130 may be a plurality of processors and memories, respectively.

The bus 110 may connect components included in the electronic device 100 with each other and control communication between components included in the electronic device 100.

The processor 120 performs a control operation to provide various services in the electronic device 100. For example, the processor 120 may decode a command received from at least one or more other components (e.g., the memory 130, the input module 140, the display module 150, the communication module 160, and the firmware control module 170) included in the electronic device 100 through the bus 110 and execute a calculation or data processing according to the decoded command.

The processor 120 may perform a control operation to execute one or more programs stored in the memory 130 and provide various services in the electronic device 100. For example, when the electronic device 100 is booted, the processor 120 may load kernel image and Random Access Memory (RAM) disc information which are stored in the memory 130 into a volatile memory (main memory region) like a RAM, initialize a kernel using the loaded kernel image, and mount system information stored in the memory 130. If firmware of an internal device (e.g., the memory 130) is updated in the firmware control module 170, the processor 120 may initialize a kernel and delay the mounting of the system information until the update of the firmware of the internal device (e.g., the memory 130) is completed. Herein, the system information may include information about a platform for an operation of the electronic device 100. The mounting of the system may indicate a series of operations such that the processor 120 loads system information which is stored in the memory 130 into a volatile memory region like a RAM to operate a system of the electronic device 100. For example, when the electronic device 100 is an electronic device which supports an Android multimedia framework, the system information may indicate a system partition including information such as an Android kernel, a system library, an application runtime, an application framework, and a core application which are mounted in an OS (e.g., a Linux kernel) of the electronic device 100.

The firmware control module 170 may perform a control operation to update firmware of the internal device (e.g., the memory 130) included in the electronic device 100. For one example, when firmware update information about the memory 130 is stored as RAM disc information, the firmware control module 170 may perform a control operation to update firmware of the memory 130 before system information is mounted by the processor 120 using the firmware update information loaded into a RAM disc region by the processor 120. For example, when a kernel is initialized by the processor 120, the firmware control module 170 may perform a control operation to update the firmware of the memory 130 using firmware update information loaded together with kernel image by the processor 120. Herein, the firmware update information may include a control command for updating the firmware of the memory 130 and data for updating the firmware of the memory 130. For example, the firmware update information may include a program for updating firmware of the internal device and new firmware of the internal device. Also, the firmware update information may be configured as a type of one or more execution files which may be executed in a kernel.

For another example, when an event for updating firmware of the memory 130 is generated while the electronic device 100 is driven, the firmware control module 170 may load firmware update information stored in the memory 130 into a volatile memory (main memory region) like a RAM, a flash memory, or a sub flash memory. The firmware control module 170 may perform a control operation to unmount system information and update firmware of the memory 130 using firmware update information loaded from the memory 130. Herein, the unmounting of the system may indicate a series of operations for removing system information loaded into a volatile memory region like a RAM to operate a system by the processor 120 from the volatile memory region.

The memory 130 stores commands or data which are received from one or more components (e.g., the processor 120, the input module 140, the display module 150, the communication module 160, and the firmware control module 170) included in the electronic device 100 or are generated by the one or more components. For example, the memory 130 may store firmware update information for updating its firmware. For example, the memory 130 may store its firmware update information in a RAM disc region adjacent to a kernel image or its certain region.

The memory 130 is logically or physically separated from a storage region which stores commands or data. The memory 130 may include a memory region (e.g., a volatile memory (main memory region) like a RAM) into which commands or data executed or processed by at least one of the processor 120 and the firmware control module 170 are loaded.

The input module (input interface) 140 may transmit commands or data generated by selection of a user of the electronic device 100 to the processor 120 or the memory 130 through the bus 110. For example, the input module 140 may include one or more of a keypad including at least one hardware button and a touch pad which may sense touch information.

The display module 150 displays videos, images, or data to the user. For example, the display module 150 may display information of an application program executed by the processor 120

The communication module 160 may perform communication between at least another electronic device 104, the server 106, or at least one peripheral and the electronic device 100. For example, the communication module 160 may support a local-area communication protocol (e.g., Wireless-Fidelity (Wi-Fi), Bluetooth, and Near Field Communication (NFC)), a network communication protocol (e.g., the Internet, a Local Area Network (LAN), a Wide Area Network (WAN), a communication network, a cellular network, a satellite network, or a Plain Old Telephone Service (POTS)), or a wired communication protocol (e.g., a USB, a High Definition Multimedia Interface (HDMI)). Herein, the communication protocols (e.g., the local-area communication protocol, the network communication protocol, and the wired communication protocol) may be supported in middleware or an Application Programming Interface (API) of the memory 130. Herein, the another electronic device as a peripheral of the electronic device 100 may include a device of the same type as the electronic device 100 or a device of a type which is different from the electronic device 100.

In above-described one embodiment of the present invention, the electronic device 100 may update the firmware of the memory 130 using the firmware control module 170. The firmware control module 170 may be configured as software and be configured as a part of a kernel which operates in a host system of the electronic device 100.

In another embodiment of the present invention, the electronic device 100 may update the firmware of the memory 130 using the processor 120.

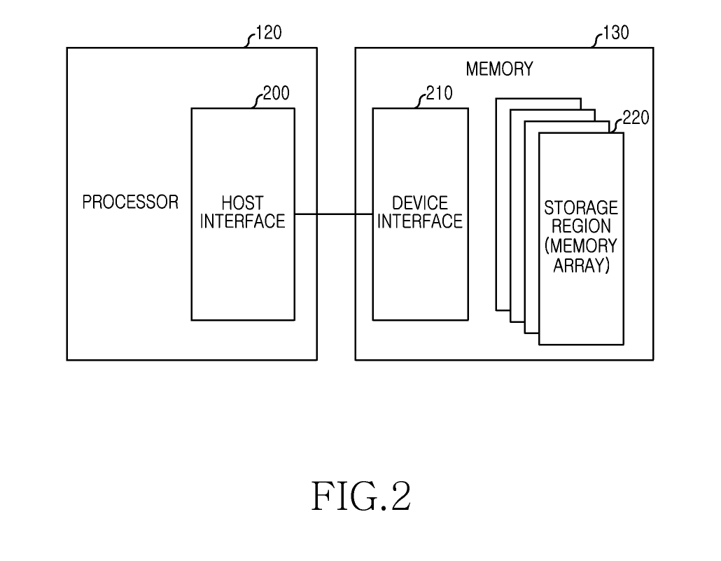

FIG. 2 is a block diagram illustrating detailed configuration of a processor and a memory of an electronic device according to one embodiment of the present invention.

Referring to FIGS. 1 and 2, the processor 120 may include a host interface 200 for controlling data transmission and reception with the memory 130.

The memory 130 may include a storage region 220 for storing data and a device interface 210 for controlling input and output of data for the storage region 220. For example, the storage region 220 may include a memory array by a plurality storage regions or one storage region (not shown).

The processor 120 may perform a control operation to update firmware for the device interface 210 of the memory 130 using firmware update information stored in the storage region 220 of the memory 130. For one example, when the electronic device 100 is booted, the processor 120 may verify kernel image and RAM disc information which are stored in the storage region 220 of the memory 130 and initialize a kernel using the verified kernel image. For example, the processor 120 may load the kernel image and the RAM disc information which are stored in the storage region 220 of the memory 130 into a volatile memory (main memory region) like a RAM and initialize the kernel using the loaded kernel image. When the kernel is initialized, the processor 120 may perform a control operation to update firmware for the device interface 210 of the memory 130 using firmware update information included in the RAM disc information. Herein, the firmware update information is loaded together with the kernel image. However, the firmware update information is included in the RAM disc information which is separated from the kernel image. The processor 120 may perform a control operation to update the firmware of the memory 130 using firmware update information in a layer for initializing the kernel and another separate layer. When the firmware of the memory 130 is updated, the processor 120 may load system information stored in the storage region 220 of the memory 130 and drive a system of the electronic device 100. Herein, the firmware update information may include a control command for updating the firmware of the memory 130 and data for updating the firmware of the memory 130.

For another example, when an event for updating the firmware of the memory 130 is generated while the electronic device 100 is driven, the processor 120 may verify firmware update information about the memory 130, which is stored in the storage region 220 of the memory 130. For example, the processor 120 may load the firmware update information for the memory 130, which is stored in the storage region 220 of the memory 130, into a volatile memory (main memory region) like a RAM, a flash memory, or a sub flash memory. The processor 120 may perform a control operation to unmount system information and update firmware for the device interface 210 of the memory 130 using firmware update information loaded from the memory 130.

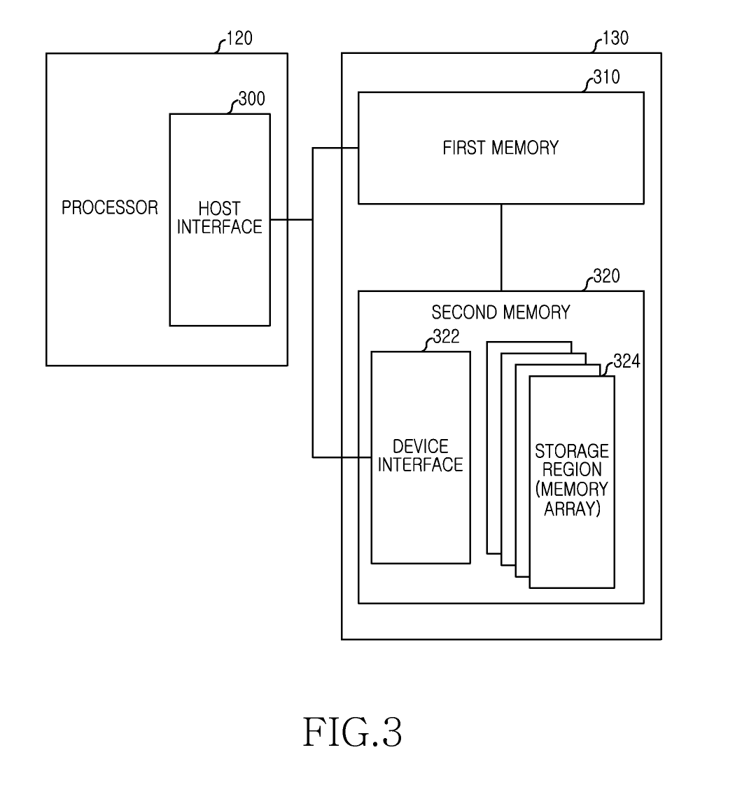

In the above-described one embodiment of the present invention, the processor 120 may load the firmware update information stored in the memory 130 into the volatile memory (main memory store) like the RAM, the flash memory, or a sub flash memory and update the firmware for the device interface 210 of the memory 130. The processor 120 may load firmware update information into an internal memory (e.g., an internal RAM) thereof or a separate memory shown in FIG. 3 later and update firmware for the device interface 210 of the memory 130.

FIG. 3 is a block diagram illustrating detailed configuration of a processor and a memory of an electronic device according to another embodiment of the present invention.

Referring to FIGS. 1 and 3, the processor 120 may include a host interface 300 for controlling data transmission and reception with the memory 130.

The memory 130 may include a first memory 310 into which data executed in the processor 120 are loaded and a second memory 320 for storing data. Herein, the first memory 310 may include at least one of a volatile memory like a RAM and a non-volatile memory such as a flash memory or a sub flash memory. The second memory 320 may include a storage region 324 for storing data and a device interface 322 for controlling input and output of data for the storage region 324. For example, the storage region 324 may include a memory array by a plurality storage regions or one storage region (not shown).

The processor 120 may perform a control operation to load firmware update information stored in the storage region 324 of the second memory 320 into the first memory 310 and update firmware for the device interface 322 of the second memory 320. For one example, when the first memory 310 includes a volatile memory like a RAM, being booted, the electronic device 100 may load kernel image and RAM disc information which are stored in the storage region 324 of the second memory 320 into the first memory 310 and initialize a kernel using the kernel image loaded into the first memory 310. When the kernel is initialized, the processor 120 may perform a control operation to update firmware for the device interface 322 of the second memory 320 using firmware update information included in the RAM disc information. Herein, the firmware update information is loaded together with the kernel image. However, the firmware update information is included in the RAM disc information which is separated from the kernel image. The processor 120 may perform a control operation to update the firmware of the second memory 320 using firmware update information in a layer for initializing the kernel and another separate layer. When the firmware of the second memory 320 is updated, the processor 120 may load (e.g., mount) system information stored in the storage region 324 of the second memory 320 into the first memory 310, and may drive a system of the electronic device 100.

For another example, when an event for updating the firmware of the memory 130 is generated while the electronic device 100 is driven, the processor 120 may load the firmware update information stored in storage region 324 of the second memory 320 into the first memory 310 (e.g., a RAM, a flash memory, or a sub flash memory). The processor 120 may perform a control operation to unmount system information and update firmware for the device interface 322 of the second memory 320 using the firmware update information loaded into the first memory 310.

In the above-described one embodiment of the present invention, the memory 130 may include the first memory 310 and the second memory 320. Herein, the first memory 310 and the second memory 320 may be logically or physically separated and configured.

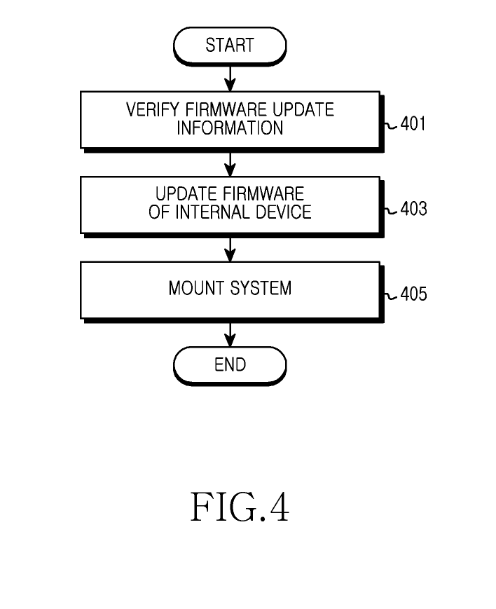

FIG. 4 is a flowchart illustrating a process of updating firmware of an internal device in an electronic device according to one embodiment of the present invention.

Referring to FIGS. 1 and 4, the electronic device 100 may verify firmware update information for updating firmware of an internal device in step 401. For example, being booted, the electronic device 100 may load kernel image and RAM disc information which are stored in the memory 130 into a RAM using a boot loader and verify firmware update information included in the RAM disc information. Herein, the firmware update information may be stored in the memory 130 of the electronic device 100 through a method like Firmware Over The Air (FOTA).

The electronic device 100 may update the firmware of the internal device (e.g., the memory 130) using the firmware update information in step 403. For example, when firmware update information about the memory 130 is included and stored in RAM disc information, the electronic device 100 may update firmware for the device interface 210 of the memory 130 using the firmware update information of the memory 130, which is loaded into a RAM disc region. For example, the electronic device 100 may update the firmware for the device interface 210 of the memory 130 using a separate module which is logically or physically separated from a module for kernel initialization.

When the firmware of the internal device is updated, the electronic device 100 may mount its system information in step 405. For example, the electronic device 100 may load system information stored in the memory 130 into a RAM.

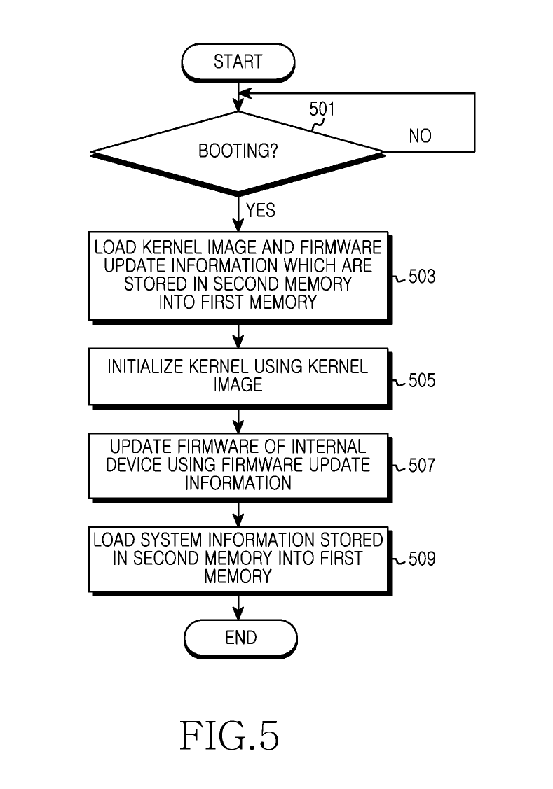

FIG. 5 is a flowchart illustrating a process of updating firmware of an internal device when an electronic device is booted according to one embodiment of the present invention.

Referring to FIGS. 1 and 5, the electronic device 100 may verify whether it is booted in step 501. For example, the electronic device 100 may verify whether it is booted by receiving power.

Being booted, the electronic device 100 may load a kernel image and RAM disc information which are stored in the second memory 320 into the first memory 310 (e.g., a RAM) in step 503.

The electronic device 100 may initialize a kernel using the kernel image loaded into the first memory 310 in step 505.

When the kernel is initialized, the electronic device 100 may update firmware of an internal device (e.g., the second memory 320) in step 507. For example, when firmware update information about the second memory 320 is included and stored in RAM disc information, the electronic device 100 may update firmware for the device interface 322 of the second memory 320 using firmware update information which is loaded into the first memory 310 (e.g., a RAM) together with the kernel image. For example, the electronic device 100 may update the firmware for the device interface 322 of the second memory 320 using a separate module which is logically or physically separated from a module for kernel initialization.

When the firmware of the internal device (e.g., the second memory 320) is updated, the electronic device 100 may mount its system information in step 509. For example, the electronic device 100 may load system information stored in the storage region 324 of the second memory 320 into the first memory 310 (e.g., a RAM).

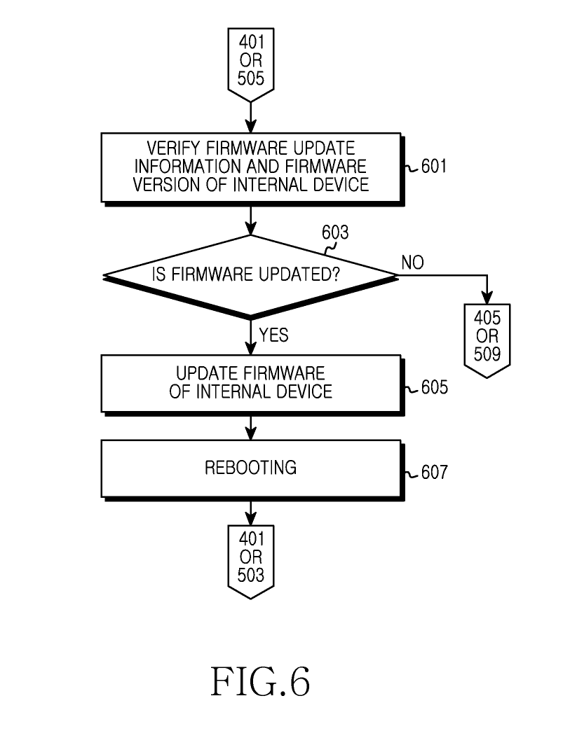

FIG. 6 is a flowchart illustrating a process of updating firmware of an internal device based on firmware version in an electronic device according to one embodiment of the present invention.

Referring to FIGS. 1 and 6, when the firmware update information is verified in step 401 of FIG. 4 or when the kernel of the electronic device 100 is initialized in step 505 of FIG. 5, the electronic device 100 may verify a firmware version of firmware update information and a firmware version of an internal device (e.g., the memory 130) for updating firmware in step 601. For example, the electronic device 100 may verify the firmware version of the corresponding internal device using a predetermined register of the internal device.

The electronic device 100 may compare the firmware version of the firmware update information with the firmware version of the internal device (e.g., the memory 130) for updating the firmware and determine whether to update the firmware for the internal device (e.g., the memory 130). For example, when the firmware version of the firmware update information is identical to or before the firmware version of the internal device (e.g., the memory 130), the electronic device 100 may determine that firmware for the memory 130 is not updated. When the firmware version of the firmware update information is after the firmware version of the internal device (e.g., the memory 130), the electronic device 100 may determine that the firmware for the internal device (e.g., the memory 130) is updated.

When the firmware for the internal device (e.g., the memory 130) is not updated in step 603, the electronic device 100 may mount its system information in step 405 of FIG. 4 or in step 509 of FIG. 5.

When the firmware for the internal device (e.g., the memory 130) is updated in step 603, the electronic device 100 may update the firmware of the internal device (e.g., the device interface 210 of the memory 130) in step 605.

When the firmware of the internal device (e.g., the memory 130) is updated, the electronic device 100 may reboot and initialize its system in step 607.

When the system is rebooted in step 607, the electronic device 100 may verify the firmware update information in step 401 of FIG. 4 or load the kernel image and the RAM disc information which are stored in the second memory 320 into the first memory 310 (e.g., the RAM) in step 503 of FIG. 5.

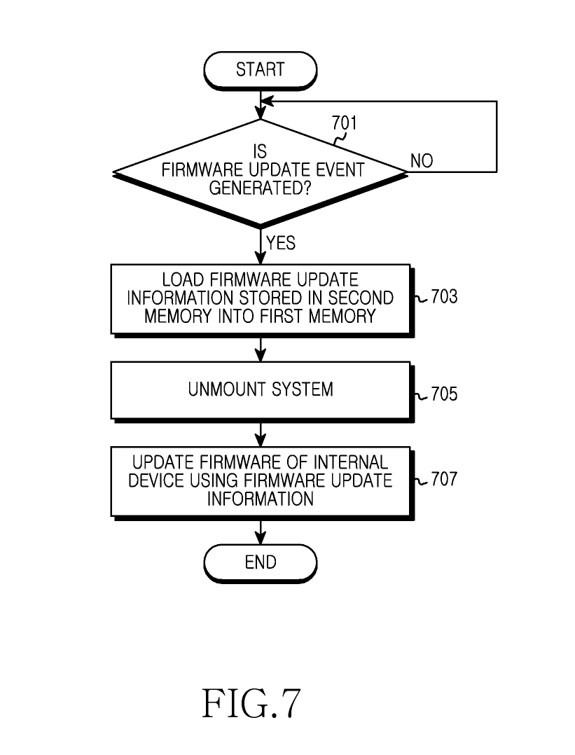

FIG. 7 is a flowchart illustrating a process of updating firmware of an internal device while an electronic device is driven according to one embodiment of the present invention.

Referring to FIGS. 1 and 7, the electronic device 100 may verify whether a firmware update event is generated while a system of the electronic device 100 is driven in step 701. For example, the electronic device 100 may verify whether an event for update of firmware is generated based on input information provided through the input module 140. Herein, the event for the update of the firmware may include an event for a system recovery mode.

When the firmware update event is generated in step 701, the electronic device 100 may load firmware update information stored in the second memory 320 into the first memory 310 (e.g., a RAM, a flash memory, or a sub flash memory) in step 703.

The electronic device 100 may unmount system information in step 705. For example, the electronic device 100 may remove loaded system information from the first memory 310.

When the system information is unmounted, the electronic device 100 may update firmware of the internal device (e.g., the second memory 320) in step 707. For example, the electronic device 100 may update firmware for the device interface 322 of the second memory 320 using the firmware update information loaded into the first memory 310 (e.g., the RAM, the flash memory, or the sub flash memory) in step 703. For example, the electronic device 100 may update the firmware for the device interface 322 of the second memory 320 using a separate module which is logically or physically separated from a module for kernel initialization.

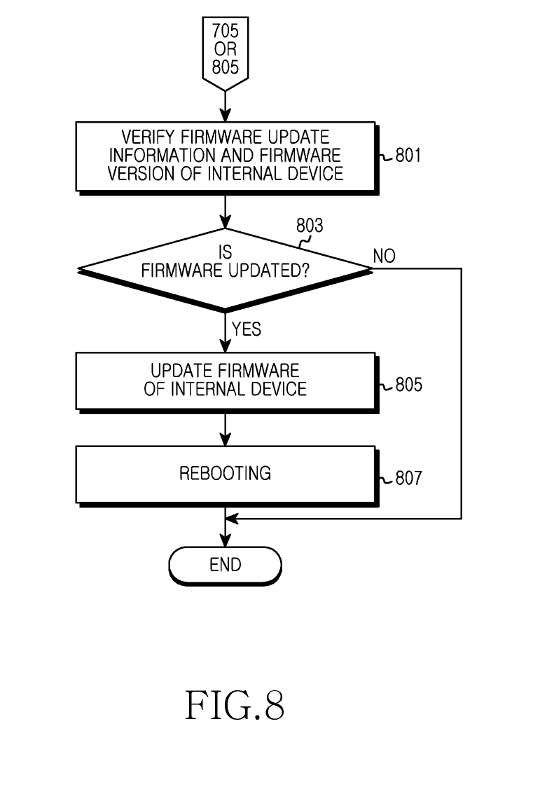

FIG. 8 is a flowchart illustrating a process of updating firmware of an internal device based on firmware version in an electronic device according to another embodiment of the present invention.

Referring to FIGS. 1 and 8, when the system information is unmounted in step 705 of FIG. 7, the electronic device 100 may verify a firmware version of firmware update information and a firmware version of an internal device (e.g., a memory) for updating firmware in step 801.

The electronic device 100 may compare the firmware version of the firmware update information with the firmware version of the internal device (e.g., the memory) for updating the firmware and determine whether to update the firmware for the internal device (e.g., the memory). For example, when the firmware version of the firmware update information is identical to or before the firmware version of the internal device (e.g., the memory), the electronic device 100 may determine that firmware for the internal device (e.g., the memory) is not updated. When the firmware version of the firmware update information is after the firmware version of the internal device (e.g., the memory), the electronic device 100 may determine that the firmware for the internal device (e.g., the memory) is updated.

When the firmware for the internal device (e.g., the memory) is not updated in step 803, the electronic device 100 may end the algorithm of FIG. 8. For another example, verifying whether to update the firmware of the internal device (e.g., the memory) based on an event for a system recovery mode, the electronic device 100 may perform rebooting in step 807.

When the firmware for the internal device (e.g., the memory) is updated in step 803, the electronic device 100 may update the firmware of the internal device (e.g., a device interface of the memory) in step 805.

When the firmware of the internal device (e.g., the memory) is updated, the electronic device 100 may reboot and initialize its system in step 807.

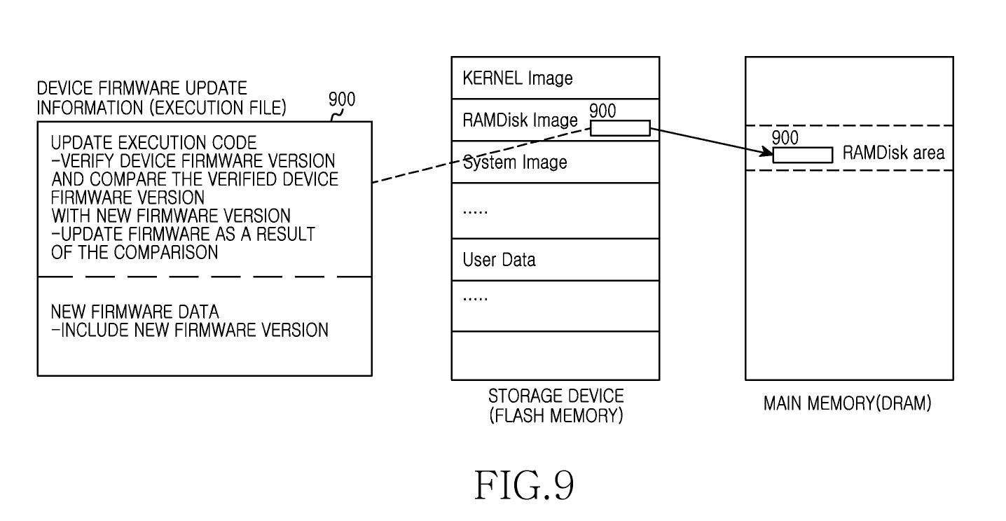

FIG. 9 illustrates configuration of firmware update information according to one embodiment of the present invention.

Referring to FIGS. 1 and 9, firmware update information 900 of an internal device may be stored as a part of a RAM disc image which is logically or physically separated from a kernel image in a storage device (e.g., a flash memory) (sub memory). For example, the firmware update information 900 of the internal device may include a control command (execution code) for updating firmware of the internal device and data for updating the firmware of the internal device. The data for updating the firmware may include new firmware data for the internal device. The control command (execution code) for updating the firmware of the internal device may include a control command provided to compare a firmware version of the internal device with a version of new firmware data included in the data for updating the firmware and execute the firmware of the internal device as a result of the comparison. Herein, the firmware update information 900 may be configured as a type of an execution file.

The firmware update information 900 may be stored or updated in a storage device through a method such as FOTA.

When the electronic device 100 is booted, the firmware update information 900 may be loaded into a RAM disc region of a main memory (e.g., a RAM or Dynamic RAM (DRAM)) by a boot loader of the electronic device 100 and be executed by the processor 120 or the firmware control module 170 of the electronic device 100. For example, the firmware update information 900 may be loaded into the RAM disc region of the main memory (e.g., the RAM or DRAM) in a time point when a kernel image is loaded into the main memory by the boot loader.

Methods according to claims of the present invention and/or embodiments described in the specification of the present invention may be implemented as hardware, software, or combinational type of the hardware and the software.

When the method is implemented by the software, a computer-readable storage medium for storing one or more programs (software modules) may be provided. The one or more programs stored in the computer-readable storage medium may be executed by one or more processors in the electronic device 100. The one or more programs include instructions for allowing the electronic device 100 to execute the methods according to the claims of the present invention and/or the embodiments described in the specification of the present invention.

These programs (software module, software) may be stored in a RAM, a non-volatile memory including a flash memory, a Read Only Memory (ROM), an Electrically Erasable Programmable ROM (EEPROM), a magnetic disc storage device, a Compact Disc-ROM (CD-ROM), a DVD or an optical storage device of a different type, and a magnetic cassette. Or, the programs may be stored in a memory configured by combination of some or all of them. Also, the configured memory may include a plurality of memories.

Also, the programs may stored in an attachable storage device which may access the electronic device 100 through each of communication networks such as the Internet, an intranet, a LAN, a Wide LAN (WLAN), and a Storage Area Network (SAN) or a communication network configured by combination of them. This storage device may connect to the electronic device 100 through an external port.

Also, a separate storage device on a communication network may connect to the portable electronic device 100.

As described above, the electronic device may stably update the firmware for the internal device by updating the firmware of the corresponding internal device in a state where input and output for the internal device (e.g., the storage device) is limited.

The electronic device may update the firmware of the internal device without newly generating host firmware by storing and executing a control command (e.g., a code) and data for updating the firmware of the internal device as an independent execution file.

It will be appreciated that embodiments of the present invention according to the claims and description in the specification can be realized in the form of hardware, software or a combination of hardware and software. Any such software may be stored in a non-transient computer readable storage medium. The non-transient computer readable storage medium stores one or more programs (software modules), the one or more programs comprising instructions, which when executed by one or more processors in an electronic device, cause the electronic device to perform a method of the present invention. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method in an electronic device, the method comprising:
updating the firmware of an internal device using firmware update information of the internal device, which is logically or physically separated from a kernel (OS) image.

2. The method of claim 1, wherein the firmware update information is stored as at least one file type in a RAM disc region, a flash memory, or a sub flash memory.

3. The method of claim 2, wherein the firmware update information is loaded into the RAM disc region in a time point when the kernel image is loaded into a RAM, when the electronic device is booted.

4. The method of claim 1, wherein the firmware update information includes a control command for updating the firmware of the internal device and data for updating the firmware.

5. The method of claim 1, wherein the updating of the firmware of the internal device comprises:
comparing a firmware version of the firmware update information with a firmware version of the internal device;
determining whether to update the firmware of the internal device as a result of the comparison; and
updating the firmware of the internal device using the firmware update information when it is determined that the firmware of the internal device is updated.

6. The method of claim 1, wherein the updating of the firmware of the internal device comprises updating firmware of a storage device included in the electronic device using the firmware update information.

7. The method of claim 6, wherein the updating of the firmware of the internal device comprises:
loading firmware update information of the storage device, which is logically or physically separated from the kernel (OS) image, into a RAM disc region of a RAM, a flash memory, or a sub flash memory; and
updating the firmware of the storage device using the firmware update information of the storage device, which is loaded into the RAM disc region, the flash memory, or the sub flash memory.

8. A method in an electronic device, the method comprising:
reading firmware update information for updating the firmware of the internal device while the electronic device is driven;
unmounting system information of the electronic device; and
updating the firmware of the internal device using the firmware update information.

9. The method of claim 8, wherein the verification of the firmware update information comprises loading firmware update information of the internal device into a RAM, a flash memory, or a sub flash memory.

10. The method of claim 8, wherein the update of the firmware of the internal device comprises updating firmware of a storage device included in the electronic device using the firmware update information.

11. A method in an electronic device, the method comprising:
loading firmware update information of the internal device, which is logically or physically from a kernel (OS) image, into a RAM disc region;
updating the firmware of the internal device using the firmware update information loaded into the RAM disc region; and
rebooting the electronic device.

12. The method of claim 11, wherein the loading into the RAM disc region comprises loading the firmware update information of the internal device into the RAM disc region in a time point when the kernel image is loaded into a RAM when the electronic device is booted.

13. An electronic device comprising:
at least one internal device; and
at least one processor,
wherein the at least one processor updates firmware of at least the one internal device using firmware update information of at least the one internal device, which is logically or physically separated from a kernel (OS) image.

14. The electronic device of claim 13, further comprising a RAM, a flash memory, or a sub flash memory,
wherein the firmware update information is stored as at least one file type in a RAM disc region of the RAM, the flash memory, or the sub flash memory.

15. The electronic device of claim 14, wherein at least the one processor loads the firmware update information into the RAM disc region in a time point when the kernel image is loaded into the RAM, when the electronic device is booted.

16. The electronic device of claim 13, wherein the firmware update information includes a control command for updating the firmware of at least the one internal device and data for updating the firmware.

17. The electronic device of claim 13, wherein at least the one processor determines whether to update the firmware of at least the one internal device as a result of comparing a firmware version of the firmware update information with a firmware version of at least the one internal device and updates the firmware of at least the one internal device using the firmware update information when it is determined that the firmware of at least the one internal device is updated.

18. The electronic device of claim 13, further comprising a storage device,
wherein at least the one processor updates firmware of the storage device using the firmware update information.

19. The electronic device of claim 18, wherein the storage device includes a storage region for storing data and a device interface for controlling input and output of the data for the storage region,
wherein at least the one processor updates firmware of the device interface included in the storage device using the firmware update information.

20. An electronic device comprising:
at least one internal device; and
at least one processor,
wherein the at least one processor verifies firmware update information of at least the one internal device for updating firmware among at least the one internal device while the electronic device is driven, unmounts system information of the electronic device, and updates the firmware of at least the one internal device for updating the firmware using the firmware update information.

21. The electronic device of claim 20, further comprising a RAM, a flash memory, or a sub flash memory,
wherein at least the one processor loads firmware update information of at least the one internal device for updating the firmware into the RAM, the flash memory, or the sub flash memory.

22. The electronic device of claim 20, further comprising a storage device,
wherein at least the one processor updates firmware of the storage device using firmware update information of the storage device.

23. The electronic device of claim 20, wherein the storage device includes a storage region for storing data and a device interface for controlling input and output of the data for the storage region,
wherein at least the one processor updates firmware of the device interface included in the storage device using the firmware update information.
